(19) United States
(12) Patent Application Publication
(10) Pub. No.: US 2003/0021436 A1
(43) Pub. Date: Jan. 30, 2003

(54) Laminated aluminum polypropylene (LAP) multi-layers loudspeaker diaphragm

(75) Inventor: Wei Chung Wu, Taipei (TW)

Correspondence Address: DOUGHERTY & TROXELL, SUITE 1404, 5205 LEESBURG PIKE, FALLS CHURCH, VA, 22041, US

(73) Assignee: Meiloon Industrial Co., Ltd.

(21) Appl. No.: 09/911,504

(22) Filed: Jul. 25, 2001

(51) Int. Cl. H04R 1/00

(52) U.S. Cl. 381/426; 381/423

(57) ABSTRACT

A laminated aluminum polypropylene (refers to LAP hereinafter) multi-layers loudspeaker diaphragm comprises different material layers to exploit the appearance feature and mechanical properties from different material. LAP diaphragm contains (1) the front layer which is made of formed aluminum foil, (2) the second layer which is injected polypropylene and (3) a bonding adhesive layer lying between the aluminum and polypropylene layers to bond two different material layers tightly and also enhance the property of internal loss. The loudspeaker with this multi layers vibrating diaphragm posses the advantages of the metal glaring appearance and mechanical properties good for quality sound reproduction and environmental resistance.

### BACKGROUND OF THE INVENTION

1) Field of the Invention

This invention relates to the structure improvement of a loudspeaker vibrating diaphragm comprises a formed alluvium layer, a polypropylene layer and an adhesive bonding layer. The structure for this multi-layers diaphragm is with both glaring metal appearance and the good vibration response in the audible range.

2) Description of the Prior Art

The conventional vibrating diaphragm is usually made of pulp. The advantages of pulp diaphragm are its low cost, lightweight and good vibrating response effect. However, the appearance treatment on the pulp diaphragm is restricted and also the weather resistance property for pulp diaphragm is not so ideal. The mechanical property for the pulp diaphragm is usually varied with the climate condition. It is also easily to get mildewed when exposed to the environment with high humidity.

The newly diaphragm made of polypropylene or aluminum foil is more durable in term of the environmental resistance and also with the glaring appearance. However, in some certain application areas, these two materials still have different merits and demerits.

The characteristics of aluminum diaphragm are good for formability and more versatile in appearance treatment. The weakness of the aluminum diaphragm is easily deflected, even cracked, due to the external force. In the real application, the apparent distortion for aluminum diaphragm will be detected due to the happening of break-up motion at the frequency up to certain level.

The vibrating response for diaphragm made of polypropylene, with high internal loss, is similar to that of diaphragm made of pulp within the audible frequency range. The polypropylene diaphragm is also superior to the diaphragm made of pulp in terms of surface smoothness and rigidity. The weakness of the polypropylene diaphragm polypropylene is its relatively heavier weight, compared with pulp and aluminum diaphragm, resulting in the sluggish response.

### SUMMARY OF THE INVENTION

In order to well use the advantages and solve the aforementioned problems from the application of commonly used material for diaphragm, this invention proposed a laminated aluminum polypropylene (LAP) multi-layers loudspeaker diaphragm. LAP multi-layer loudspeaker diaphragm composed of the front layer which is made of formed aluminum foil and the second layer whose material is polypropylene. A bonding adhesive layer lying between the front and second layers is used to bond two layers with different material tightly. The loudspeaker with the proposed multi layers structure diaphragm are able to demonstrate the advantages from two different materials—metal glaring appearance and the excellent mechanical properties required for the reproduction of the good sound quality.

### BRIEF DESCRIPTION OF THE DRAWINGS

Hereinafter, preferred embodiments of the present invention will be described with reference to the accompanying drawings in which:

FIG. 1 is an exploded diagram showing the structure of the multi-layer diaphragm

FIG. 2 is an explanatory diagram showing the assembly of the related layers

FIG. 3 is an explanatory diagram in planar view

FIG. 4 is a diagram enlarging a local portion to explain the interface condition for different layers.

### DETAILED DESCRIPTION OF THE PREFERRED EMBODIMENT

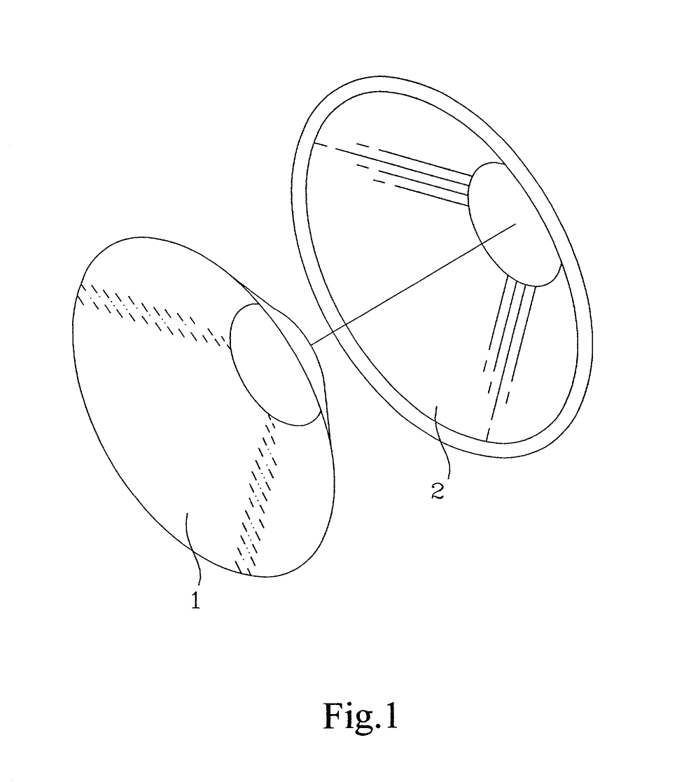

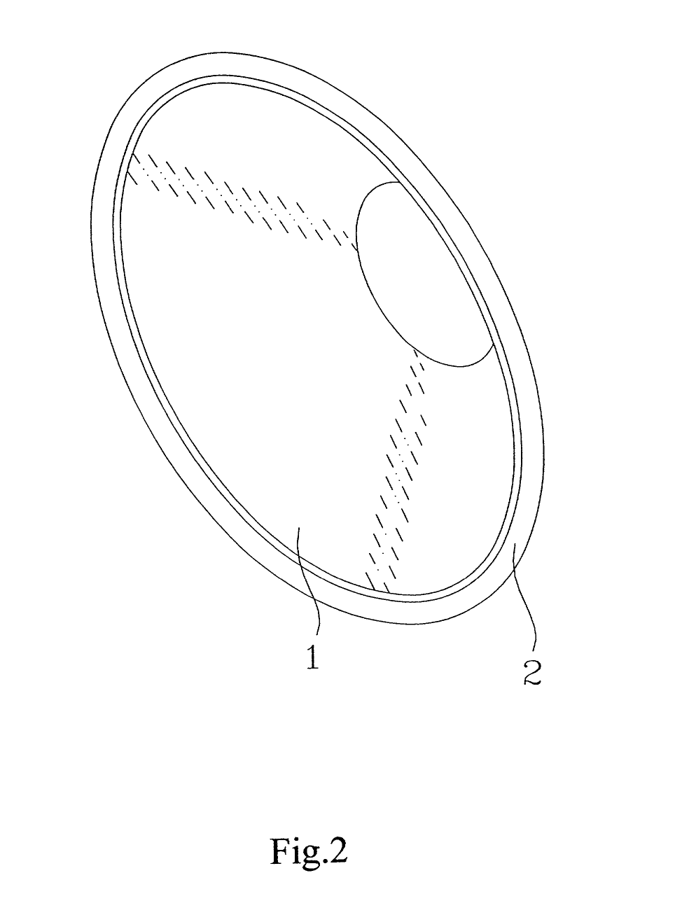

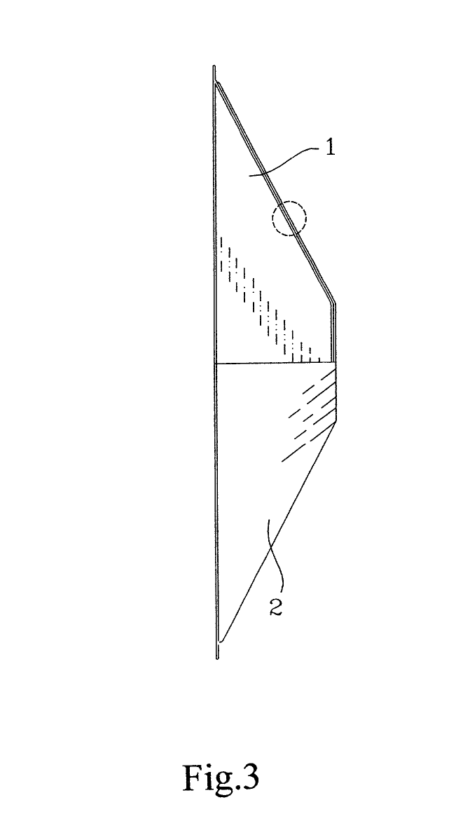

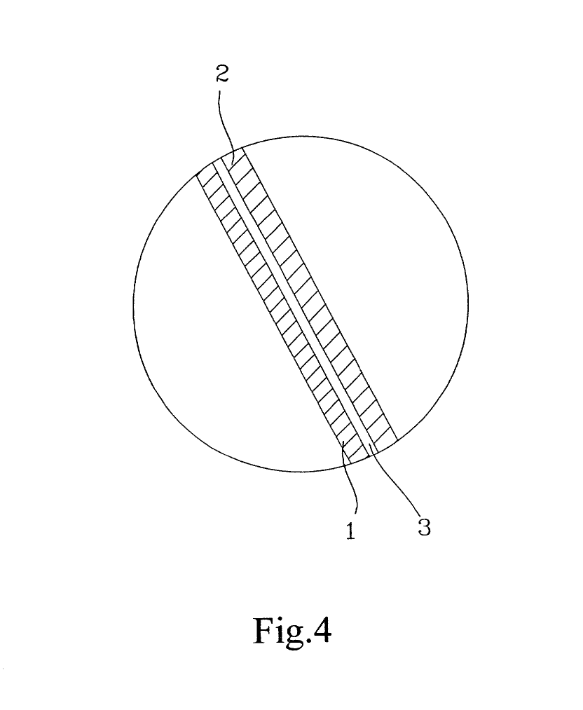

Referring to FIGS. 1 to 4, a loudspeaker vibrating diaphragm according to the present invention comprises an aluminum foil layer 1, polypropylene layer 2 and adhesive bonding layer 3. The adhesive bonding layer lying between two layers is used to bond two different material layers tightly.

The aluminum foil layer is formed in accordance with conventional metal forming process and the polypropylene layer is formed in the injection mold respectively. Two layers are bonded by forceful glue as the interface media which can also enhance the property of internal loss. After bonding, the second layer will be located in the outside concentrical circle of the first layer. The alternative method is to apply the forceful glue on the back of the first layer and, then, moved into the injection mold. By injecting the polypropylene to the mold, the second polypropylene layer then can be bonded with first layer directly. This multi layer combination structure can resolve the defects from the pulp diaphragm or polypropylene diaphragm only. Moreover, the structure can possess the advantages of two materials in terms of appearance preference and mechanical properties such as high rigidity and internal loss to deliver the good sound quality and improve the environmental resistance

As is understood from the above description, the loudspeaker vibrating diaphragm produced in accordance with present invention can greatly surpass the conventional diaphragm with the single material only in terms of function, vibrating response and appearance treatment. Therefore, the inventor submits the patent application by following the rules.

While the presently preferred embodiments of this invention have been shown and described above, it is to be understood that these disclosures are for the purpose of illustration and that various changes and modifications may be made without departing from the scope of the invention as set forth in the appended claims.

1. A loudspeaker vibrating diaphragm according to the present invention, comprises an aluminum foil layer 1, polypropylene layer 2 and adhesive bonding layer 3. The adhesive bonding layer lying between two layers is used to bond two different material layers tightly.

2. The diaphragm according to claim 1 and 2, wherein the aluminum foil layer is formed in accordance with metal forming process and the polypropylene layer is formed in the injection mold respectively. Two layers are bonded by forceful glue as the interface media.

3. The diaphragm according to claim 1 to 2, wherein apply the forceful glue on the back of the first layer and moved into the injection mold. By injecting the polypropylene to the mold, second polypropylene layer then can be bonded with first layer directly.
